(19) United States
(12) Patent Application Publication
(10) Pub. No.: US 2012/0078687 A1
(43) Pub. Date: Mar. 29, 2012

(54) SYSTEM AND METHOD FOR LOWEST COST AGGREGATE ENERGY DEMAND REDUCTION

(75) Inventors: Soumyadip Ghosh, PeekSkill, NY (US); Jayant R. Kalagnanam, Tarrytown, NY (US); Dmitriy A. Katz-Rogozhnikov, Ossining, NY (US); Mark S. Squillante, Pound Ridge, NY (US); Xiaoxuan Zhang, Stony Brook, NY (US)

(73) Assignee: INTERNATIONAL BUSINESS MACHINES CORPORATION, Armonk, NY (US)

(21) Appl. No.: 12/890,119

(22) Filed: Sep. 24, 2010

(51) Int. Cl. G06Q 30/00; G06F 17/00

(52) U.S. Cl. 705/14.1; 705/412

(57) ABSTRACT

A method, apparatus and computer program product for determining lowest cost aggregate energy demand reduction at multiple network levels such as distribution and feeder networks. An algorithm for an optimal incentive mechanism offered to energy customers (e.g. of a utility power entity) that accounts for heterogeneous customer flexibility in load reduction, with the demand response realized via the utility's rebate signal and, accounts for temporal aspects of demand shift in response for rebates. A mathematical formulation of a cost minimization problem is solved to provide incentives for customers to reduce their demand. A gradient descent algorithm is used to solve for the optimal incentives customized for individual end users.

### BACKGROUND

The present invention relates to smart grid technologies as it pertains to energy usage, and, more particularly, to a model for generating incentive mechanisms for energy consumers at multiple network levels for determining a lowest cost aggregate energy demand reduction.

The advent of Smart Grid technologies such as digital communication devices and advanced metering infrastructures (AMI) has facilitated a better environment for sharing information and data more readily between customers and utilities in a timely fashion. This has focused attention on distributed customer demand response mechanisms such as dynamic pricing or incentive schemes as an effective control signal that improves the efficiency of energy usage. Energy markets share several key characteristics with standard revenue management models: demand is highly variable over both the time-axis and the price-axis, while supply or generation capacity is relatively inflexible over short time horizons. Energy retailing utilities or generating companies may suffer a shortfall in committed supply during peak periods of usage, and this imbalance currently leads to high operating costs due to procurement from secondary spot market sources.

Dynamic pricing offers customers' time-varying electricity prices on a day-ahead or real-time basis, which includes critical peak pricing (CPP) programs, real-time pricing programs (RTP), and peak time rebates (PTR). A review of 17 recent dynamic pricing models can be found in the reference to A. Faruqui and S. Sergici entitled “Household response to dynamic pricing of electricity a survey of seventeen pricing experiments,” Journal Vol, vol. 20, no. 8, pp. 68-77, 2007.

The incentive design problem determines rebates provided to end-users over a fixed tariff to induce a reduction in energy usage. Demand response is modeled as a version of utility or benefit functions, and aggregate demand reduction results from each customer maximizing their utility function. In a reference to Faruqui and Alvarado entitled “Designing incentive compatible contracts for effective demand management,” IEEE Transactions on Power Systems, vol. 15, no. 4, pp. 1255-1260, 2000, there is described how a quadratic benefit function is applied to design a group of incentive contracts that customers can voluntarily choose from.

However, it would be highly desirable to provide an optimal rebate plan for a utility to realize load reduction when the need arises and, further, that generates a plan that is customized for each end user.

### SUMMARY

In one aspect there is provided a system, method and computer program product that computes a customized, time varying rebate plan for each of plurality of users, e.g., each customers, to minimize a utility operating cost.

The energy utility dispatches these virtual generators based on their unique characteristics through rebate incentives. This rebate rate mechanism is optimal in that the utility can achieve the minimal total operating cost, which includes both rebates paid to all the customers and the cost paid on the spot market in case of shortfalls.

According to one aspect, there is provided a system, method and computer program product for estimating a price for determining an aggregate energy demand reduction for plurality of end-users of an entity supplying power to the end-users, the method comprising: a) receiving, at a processor device, data including a plurality of energy users i including, for each energy user, their demand level for energy usage, and an incentive rebate cost per unit of demand reduction; b) generating a customized time-varying incentive plan for each individual user i, in a defined time period, by minimizing the total incentive rebate amounts that the entity pays to each end-user i for load reduction, and a total purchasing cost in case of a load shortage; c) communicating signals from the entity to each respective user i, the signals carrying data representing an incentive plan calculated to reduce the user i's energy demand for the time period, wherein a cost expenditure of the entity is minimized.

Further to this aspect, the objective function OBJ is formulated as:

$$E \{ {\sum }_{i = 1}^{K} {{r}_{i} ( {\tilde{d}}_{i} - {d}_{i}^{*} )}^{+} + {c [ D - G - {\sum }_{i = 1}^{K} ( {d}_{i} - {d}_{i}^{*} ) ]}^{+} \}$$

subject to a constraint that

dᵢ*=dᵢ−ƒᵢ(aᵢ,rᵢ)
where i is i=1, . . . , K, K is total number of end-users; G is total generation capacity; dᵢ is demand level for user i before rebate; D is total demand before rebate, where

$$D = {\sum }_{i = 1}^{k} {d}_{i}$$

where \tilde{d}\tilde{dᵢ} is forecast demand level before rebate; dᵢ* is demand level after rebate; fᵢ(aᵢ, rᵢ) is a demand reduction function characterizing how user i responds to a given rebate value, where aᵢ is an user's rebate-demand elasticity; and rᵢ is a rebate per unit of demand reduction; and, c is a current marginal market price for purchasing energy for excess load after incentives are offered, and ( [symbol] −dᵢ*) is the Load Reduction.

Alternatively, the system and method includes adjusting the above objective function to also allow the selling of generation capacity to the spot market in addition to purchasing energy therefrom.

In a further aspect, the generating a customized time-varying incentive plan for each user is calculated for multiple time periods, wherein the objective function OBJ is formulated as:

$$E \{ \frac{1}{T} [ {\sum }_{i = 1}^{T} {\sum }_{i = 1}^{K} {{r}_{i , t} ( {d}_{i , t}^{ref} - {d}_{i , t}^{*} )}^{+} + {\sum }_{t = 1}^{T} {{c}_{i} [ {D}_{t} - {G}_{t} - {\sum }_{i = 1}^{K} ( {d}_{i , t}^{′} - {d}_{i , t}^{*} ) ]}^{+} ] \}$$

subject to a constraint that

d_{i,t}*=d_{i,t}′−ƒ_{i,t}(a_{i,t},r_{i,t}), i=1, . . . , K, t=1, . . . , T
and subject to a further constraint that

$${d}_{i , t}^{′} = {d}_{i , t} + {\sum }_{j = 0}^{t - 1} δ {v}^{j} {f}_{i , t} ( {a}_{i , t - 1 - j} , {r}_{i , t - 1 - j} ) ,$$

where i is i=1, . . . , K, t=1, . . . , T represents the multiple time-periods and T represents a time horizon, G, represents a total generation capacity at time t; d_{i,t} is a demand level before rebate at time t if no load reduction occurs at times 1, . . . , t−1; d_{i,t}* is a demand level after rebate; d_{i,t}′ is an actual demand level before rebate at time t with positive load reduction at time 1, . . . , t−1, and models, for a user i, a shifting of load from one period to subsequent periods when responding to an entity's communicated incentive signals, wherein δ, ν are factors that determine an amount of load that is shifted from one time period to subsequent time periods; Dₜ is a total actual demand before incentive at time t, where

$${D}_{i} = {\sum }_{i = 1}^{K} {d}_{i , t}^{′} ;$$

[symbol] is a forecast for d′i,t, the demand level before incentive; d_{i,t}^{ref} is a reference demand level below which load reduction by i qualifies for incentive at time t; r_{i,t} is a rebate per unit of demand reduction at time t; α_{i,t} is a user's willingness to reduce load at time t; f_{i,t}(a_{i,t}, r_{i,t}) is a demand reduction function for user i with rebate elasticity a_{i,t} and rebate rate offered r_{i,t} and, cₜ a marginal market price at time t to be purchased in event of load shortage; and (d_{i,t}′−d_{i,t}*) is the Load Reduction for user i at time t,
   the method computing for each user i, a value of reducing load for a peak period at an expense of shifting load to later time periods.

Alternatively, the system and method includes adjusting the above objective function to also allow the selling of generation capacity to the spot market in addition to purchasing energy therefrom.

A computer program product is provided for performing operations. The computer program product includes a storage medium readable by a processing circuit and storing instructions run by the processing circuit for running a method. The method is the same as listed above.

### BRIEF DESCRIPTION OF THE DRAWINGS

The objects, features and advantages of the present invention will become apparent to one skilled in the art, in view of the following detailed description taken in combination with the attached drawings, in which:

FIG. 1 depicts an overview of one embodiment of a system employing the method and apparatus for determining lowest cost aggregate energy demand reduction at multiple network levels according to one embodiment;

FIG. 2 depicts a schematic of all end users on a feeder network 201 where each user has a price elasticity represented by the demand response curves 26 and 27 in FIG. 1.

FIG. 3A depicts a first table listing example parameter combinations for (G, σ, c, dₘₐₓ) in implementing the model using a Linear Bounded Load Reduction Function, and, FIG. 3B depicts a second table listing example parameter combinations for (G, σ, c, dₘₐₓ) in implementing the model using a Non-Linear Load Reduction Function according to one embodiment;

FIG. 4A,B depict example plots of an example rebate

$$r vs . \frac{σ}{a}$$

for example linear load reduction functions ƒ according to one embodiment;

FIG. 5A,B depict example plots of an example rebate

$$r vs . \frac{σ}{a}$$

for example nonlinear load reduction functions according to one embodiment;

FIG. 6 shows example plots depicting the original demand, the after-rebate demand and load reduction as functions of time in one example application; and,

FIG. 7 illustrates an exemplary hardware configuration performing a method of demand aggregation based estimation of virtual generation in one embodiment.

### DETAILED DESCRIPTION

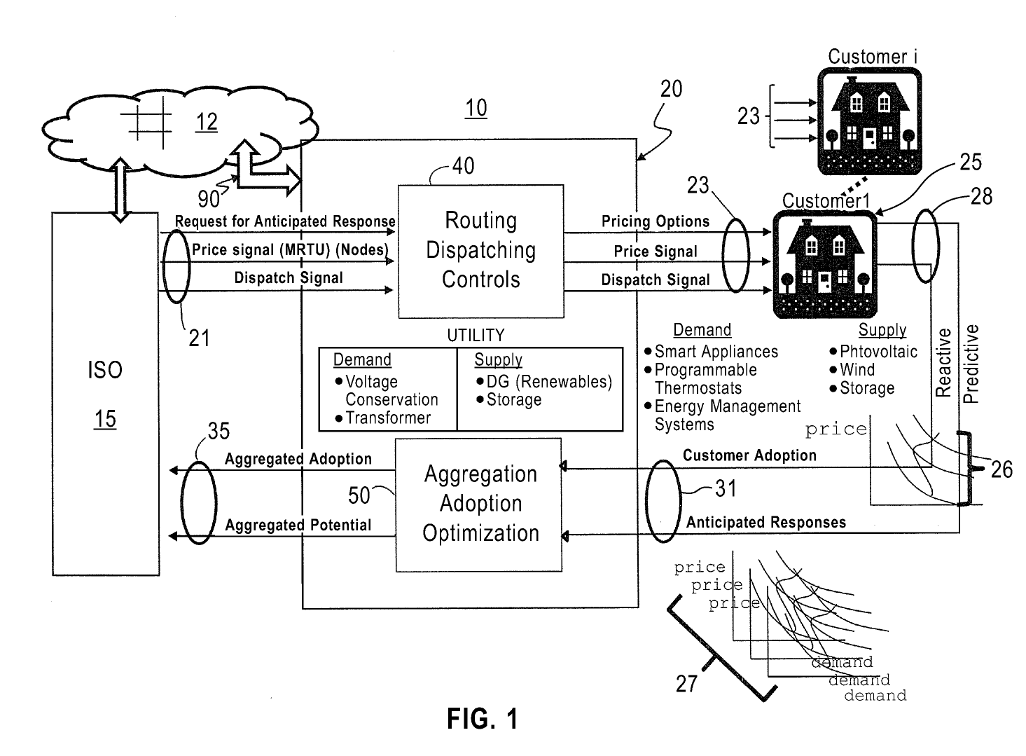

FIG. 1 depicts a system and method 10 for determining lowest cost aggregate energy demand reduction at multiple network levels. As shown in FIG. 1, in one aspect, a Smart Grid or “grid” 12, or any intelligent, self-monitoring power grid that accepts any source of fuel (coal, sun, wind, nuclear, fossil fuel) and transforms it into a consumer's end use (heat, light, warm water) with minimal human intervention is employed. Grid 12 is available to an Independent Service operator (“ISO”) 15 that provides a link between the grid 12 and a utility company 20. The ISO is employed to have the ability to utilize the demand flexibility of the utility's customers as a source of virtual generation. In effect, customers 25 such as large commercial users, retail operations or consumer homes are influenced to shift or reduce their demand in response to incentive signals 23 communicated to the customers allowing optimization of a consumer's energy usage. This method of virtual-demand generation, or demand reduction, is an advantage for utilities 20 on the Smart Grid 12: as this option of virtual-demand generation, or demand reduction, is instantly initiated via smart metering signals 21 and 23 during peak periods at almost zero start-up cost. In one embodiment, it can serve to hedge the utility's financial risk exposures by allowing fine control on the utility's demand-side flexibility.

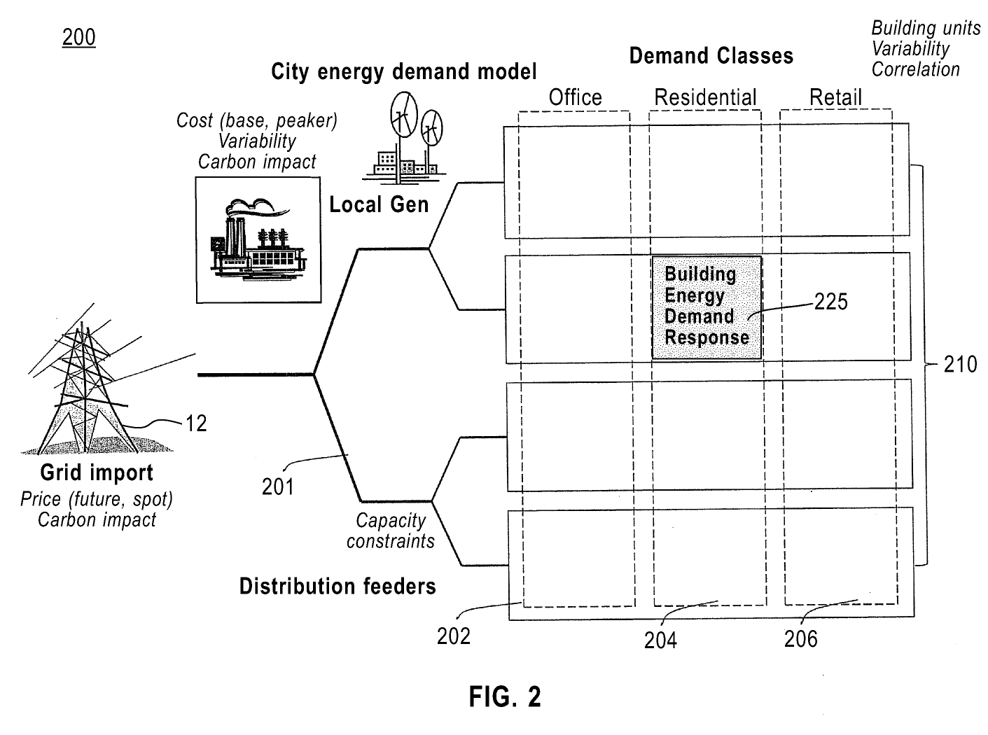

In view of FIG. 2, employed at the Smart Grid 12 is a method and apparatus for determining lowest cost aggregate energy demand reduction at multiple network levels, e.g., distribution and feeder networks 200. The methodology provides for an optimal incentive mechanism that is offered to energy customers at each level. This methodology accounts for heterogeneous customer flexibility in load reduction; and a demand response 225 realized via a utility's rebate signal. In a further aspect, the methodology described herein accounts for temporal aspects of demand shift in response for rebates (costs can be financial, social, etc.). Examples of incentive mechanism include rebates, pricing, etc.

As described herein, the system and method employed by the invention at different levels of the smart grid includes modeling a dynamic pricing problem, e.g., for both single-period and multiple-period formulations, both with the objective of minimizing the utility's total operating costs. This includes incentive compensation to end-users for load reduction as well as spot market prices paid to purchase additional units to cover any remaining load shortage.

The ability of each customer to shift or reduce demand is governed by various factors such as price-demand elasticity, demand variability and flexibility over time. A load reduction function is used that maps a customer's load reduction amount as a (noisy) function of the rebate rate offered. Both linear and nonlinear load reduction functions are considered.

The method further includes modeling a case where end-users have been customers of the utility long enough for the utility to possess a reasonable forecast of each end-user's elasticity (e.g., from their energy demand/usage history).

In one embodiment, a set of algorithms are employed for estimating the minimum cost for different levels of demand reduction (using demand response) and communicate to utilities and/or customers optimal pricing or rebate offerings.

In one embodiment, an example of hierarchical control is the ability to match supply to demand using various information or price signals. Given the price elasticity of demand for different end users (along with associated uncertainty in the response) there is estimated price signals for each end user “i” that minimizes the expected cost of reducing the demand by a required amount. In one embodiment, a set of algorithms are employed for estimating the minimum cost for different levels of demand reduction (using customers' demand response curves 26 shown in FIG. 1) and communicated subsequently to end-users (consumers) are the optimal pricing or rebate offerings.

In the embodiment shown in FIG. 1, a dispatch control 40 and aggregation module 50 are employed at the utility 20 to determine and implement the optimal rebates to incentivize customers to reduce their demand load. Signals 23 and 28 illustrate an aspect of these interactions between the utility and its customers, with signals 23 providing rebate input to customers and signals 28 providing customer response back to the utility. As further shown in FIG. 1, signals 21 and 35 illustrate interactions between the ISO and its utilities, with signals 21 providing the utility price-based incentive to reduce its demand and 35 providing the utility response back to the ISO.

More particularly, one example scenario for an ISO/utility 15/20 is where the ISO 15 requests of the utility 20 for a given time period an estimate of its anticipated (demand reduction) response via wired or wireless communicated signals 21 that specify the desired levels of load reduction imposed upon the utility. These request signals from the ISO are routed to a routing dispatch controller 40 at the utility 20 that processes the respective request signals, employs a gradient descent algorithm solver to solve an objective function and calculate the incentives, and communicates appropriate incentive signals 23 to the customers including, but not limited to information such as price options, price signals and dispatch signals that specify the rebate incentives offered to different customers for various levels of load reduction.

For example, the calculated incentive or rebate signals 23 communicated to customers in a single-period problem may indicate: a 5% rebate for customers 1, . . . , j; a 6.5% rebate for customers j+1, . . . , k; etc., with the expectation that customers will reduce their respective energy demands in response to these rebate signals. With respect to the calculated incentive or rebate signals 23 for customers in a multi-period problem an example result may be: a 5% rebate for customers 1, . . . , j in period 1 for example, a 3% reduction in period 2, and so on; 6.5% rebate for customers j+1, . . . , k in period 1, 8% rebate in period 2, and so on etc. Corresponding to this, example signals 28 communicated by customers to the utility for customers in single-period problem may indicate, for example: a 2% reduction by customer 1; 3% reduction by customer 2; 8% reduction by customer 3; etc.; while example results of signals 28 for customers in multi-period problem may indicate, for example: 2% reduction by customer 1 in period 1, 4% reduction in period 2, and so on; 3% reduction by customer 2 in period 1, 1% reduction in period 2, and so on; 8% reduction by customer 3 in period 1, 4% reduction in period 2, and so on, etc.

The utility responds by providing back to the ISO an aggregated response estimate via wired or wireless communicated signals 35 that specify the estimated anticipated levels of demand reduction from customers and a plan for any additional energy required from the spot market. Against this estimate, the utility 20 dispatches prices, e.g., via wired or wireless communicated signals 23 to its customers. ISO 15 and utility 20 further supply energy or power (including for example, wind, photovoltaic, storage, gas, electric, etc.) 90 from or to the spot market 12, for example, to various end-user customers as shown in FIG. 2 via a distribution network 200. For the ISO 15 to generate these estimates a demand aggregation method is used to compute the price settings and cost of reduction to customers. That is, the gradient descent algorithm may be further employed in ISO module 15 such that the ISO can exploit the solution to cause utilities to reduce their load with the utility similarly doing the same with its customers.

Thus, as shown in FIG. 1, in one aspect, each customer is modeled according to their demand response, obtained/estimated from demand history or through other means, e.g., as received and/or maintained by the utility or like data that can be used to determine the end-user's demand elasticity. Signals 28 representing demand responses of each end-user, e.g., customer “i”, for a current or future time period are provided to the utility 20. That is, demand response data 26 representing, e.g., current customer reactive demand adopted as a function of a current price in a current time interval or, demand response data 27 representing anticipated or predictive end-user demand, i.e., demand response curves with uncertainty for different end users as a function of price, are communicated back to the utility 20. At the utility 20, an aggregation module 50 is implemented to perform demand aggtegation, adoption and optimization as described herein. That is, module 50 receives the actual response by the utility customers to the previous demand reduction rebates, i.e., module 50 receives inputs representing the realized energy usage which are then aggregated by the utility to represent the overall energy usage by its customers. The utility then reacts in module 50 to determine its demand reduction and/or additional energy needs. The output of module 50 is then the actual response by the utility to the ISO, which in turn performs similar aggregation and follow-up actions within module 15. Thus, having secured at aggregation module 50 the current adapted demand aggregation and the potential demand aggregation for the ISO/utility, the utility issues rebates as calculated herein for each end user, and dispatches signals having incentive rebate offerings to the respective end users. The ISO, in turn, needs to solve a similar problem as the utility to determine how its demand is satisfied.

While the example provided herein with respect to FIG. 1 is in respect of actions performed at the ISO/utility level, it can equally apply at other levels of the energy distribution hierarchy shown in FIG. 2 where an “incentive” signal, including the calculated rebates for each customer, is communicated to the respective customers or, classes of customers, for their action/response. FIG. 2 particularly depicts a schematic of all end users on an example feeder (energy distribution) network 200 where each user has a price elasticity represented by the demand curves shown in FIG. 1. As represented in FIG. 2, demand users include classes of users such as offices 202, residential 204 (e.g., homes) and commercial 206, e.g., businesses such as retail stores. A network of distribution feeders 201 import the power from grid 12 in response to the aggregated reactive and potential demand, and the utility provides power to the demand users, organized according to zones 210 corresponding to a respective demand class, for example. Thus, in one aspect, the system and method is applied at multiple levels of the energy distribution hierarchies such as shown in FIG. 2 where the various levels at which the method can be applied include: across multiple classes of demand for a utility (e.g., office, residential, retail) within a grid of local generation; across multiple grids of local generation, e.g., within a city energy demand model; across multiple local generation distribution feeders; and so on within regional grids, across regional grids, within the national grid, across national grids (e.g., US and Canada). The time scale at which the system and method is applied may depend upon the level at which the system and method is applied. In the model described, class is an abstraction that allows the ISO/utility to differentiate among different groups of entities.

Further, while the energy distribution system of FIG. 1 is oriented at the level of an ISO consisting of an ISO, a utility and the utility's residential customers, this is illustrative of one level at which the present invention can be applied, where the utility uses the system and method to determine the demand reduction rebates to minimize the costs to the utility. The problem here is how to best satisfy anticipated demand with respect to the cost tradeoff between the costs of reducing anticipated demand (via demand reduction by customers induced by rebates) and the costs of obtaining additional energy on the spot market (where the utility can also make money by selling energy to the spot market).

In one embodiment, the cost tradeoff is modeled as a corresponding dynamic pricing problem formulated as a stochastic optimization problem whose solution minimizes the total virtual generation cost to an energy utility. That is, the ISO calculates estimated price signals for each end user that minimizes the expected cost of reducing the demand by a required amount. This problem may be formulated for both single-period and multi-period cases.

In one embodiment, a gradient descent algorithm is provided to solve different formulations of the stochastic optimization problem.

Various structural results on the optimal rebate scheme are further derived. This includes: identifying a threshold that segments customers for whom no dynamic pricing adjustments should be given. These results motivate a heuristic policy for the single-period problem that segments the customers according to their willingness and likelihood to reduce load. In a multi-period instance of the problem, results show that customers with higher load flexibility over time receive the larger dynamic pricing adjustments, and vice versa. Moreover, for the same supply shortfall, incentives offered after peak periods are higher than those before peak periods. The smart-grid demand response framework considered provides significant benefits to energy customers and utilities as well as to higher levels of the energy distribution hierarchy. In addition, the results of the demand response optimization can be used as input to or in conjunction with other smart-grid applications, such as the orthogonal problem of risk management of multiple sources of electric generation including renewables.

Single Period Problem

In a single period formulation/solution there is omitted constraints on the length of this period. A formulation, and numerical experiments and theoretical results for the single period problem is now provided.

The single-period formulation includes the following parameters (with subscripts i=1, . . . , K representing various end-users):

K Total number of end-users;

G Total generation capacity;

dᵢ Demand level for user i before rebate;

D Total demand before rebate, where

$$D = {\sum }_{i = 1}^{k} {d}_{i} \qquad ( 1 )$$

where [symbol] is Forecast demand level before rebate (this represents the level below which user i's usage qualifies for the rebate);

dᵢ* is Demand level after rebate;

rᵢ Rebate per unit of demand reduction;

ƒᵢ(aᵢ, rᵢ) General load demand reduction function;

aᵢ End-user i's rebate-demand elasticity;

Load Reduction LR ( [symbol] −dᵢ*)⁺ only positive value applicable (zero if value is negative);

Load Reduction LR_{EQ}=load reduction under the assumption that all rebates rᵢ are the same for all i (equal-rebate plan);

Obj denotes the optimal objective value under the discriminatory rebate plan of the present invention;

Obj_{EQ} denotes the optimal value obtained for the equal-rebate plan;

c is the Spot market price;

The following objective is sought to be optimized:

$$\begin{matrix}min E \{ {\sum }_{i = 1}^{K} {{r}_{i} ( {\tilde{d}}_{i} - {d}_{i}^{*} )}^{+} + {c [ D - G - {\sum }_{i = 1}^{K} ( {d}_{i} - {d}_{i}^{*} ) ]}^{+} \} & ( 2 ) \\ s . t . {d}_{i}^{*} = {d}_{i} - {f}_{i} ( {a}_{i} , {r}_{i} ) , i = 1 , … , K . & ( 3 )\end{matrix}$$

The first term in the objective function (2) sums up the total rebate amount that the utility pays to each end-user for load reduction from the (pre-announced) forecast level [symbol] , and the second part of (2) is the total purchasing cost from the spot market in case of load shortage. Let Obj denote the objective function (2).

Assume {dᵢ} has a normal distribution N(μᵢ, σᵢ), where μᵢ (mean of distribution) and σᵢ (standard deviation) are known to the utility from historical data. The formulation (2), in one embodiment, is solved using a steepest descent method. For general ƒᵢ, the derivative has the form

$$\frac{\partial Obj}{\partial {r}_{i}} = Φ ( {α}_{i} ) [ {f}_{i} + {r}_{i} \frac{\partial {f}_{i}}{\partial {r}_{i}} + {\tilde{d}}_{i} - {μ}_{i} ] + φ ( {α}_{i} ) {σ}_{i} - c Φ ( β ) \frac{\partial {f}_{i}}{\partial {r}_{i}} , \\ where \\ {α}_{i} = \frac{{\tilde{d}}_{i} + {f}_{i} - {μ}_{i}}{{σ}_{i}} , β = \frac{{\sum }_{i = 1}^{K} {μ}_{i} - {\sum }_{i = 1}^{K} {f}_{i} - G}{\sqrt{{\sum }_{i = 1}^{K} {σ}_{i}^{2}}} , and , \\ φ ( x ) = \frac{1}{\sqrt{2 π}} {e}^{- \frac{{x}^{2}}{2}} , Φ ( x ) = Prob [ X \leq x ] , X : N ( 0 , 1 ) . \qquad ( 4 )$$

In one embodiment, the load reduction functions ƒᵢ satisfy a condition that

$${\frac{\partial {f}_{i} ( {a}_{i} , {r}_{i} )}{\partial {r}_{i}} \vert}_{{r}_{i} = 0} = {a}_{i} , i = 1 , … , K . \qquad ( 5 )$$

Two cases of ƒᵢ (aᵢ, rᵢ) are considered where condition (5) is satisfied. In one, the load reduced linearly increases in the rebate rate rᵢ until it reaches an upper bound dₘₐₓ,

In one case:

ƒᵢ(aᵢ,rᵢ)=min {aᵢrᵢ,dₘₐₓ}, i=1, . . . , K. (6)

The other case is where ƒᵢ (aᵢ, rᵢ) is nonlinear and converges to dₘₐₓ as

$${f}_{i} ( {a}_{i} , {r}_{i} ) = {d}_{ma {x}_{i}} - \frac{1}{{a}_{i} {r}_{i} + \frac{1}{{d}_{ma {x}_{i}}}} , i = 1 , … , K . \qquad ( 7 )$$

In practical applications, the load reduction is expected to have an increasing marginal cost, and concave load reduction functions are implemented in the model. Due to this increasing marginal cost nature of both of the ƒᵢ (aᵢ, rᵢ) considered, the total cost for the utility is convex. In one embodiment, a gradient-descent based algorithm is implemented to obtain solutions to the optimization problem (2), i.e., that provides optimal incentives. The steepest descent method is used in one embodiment with the gradient updated by (4). That is, using Steepest Descent Method such as described in the reference entitled “Nonlinear programming: theory and algorithms” by M. S. Bazaraa, Hanif D. Sherali, C. M. Shetty, an initial vector r⁰ is first chosen and a convergence criteria. In one embodiment, Assuming dᵢ follows N(μᵢ, σᵢ), calculate the steepest descent direction by using equation (4).

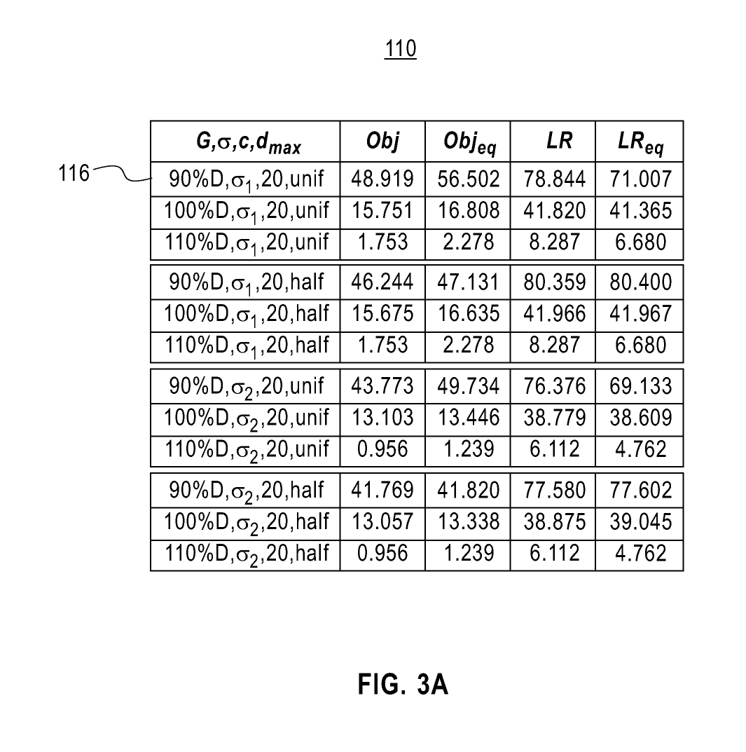

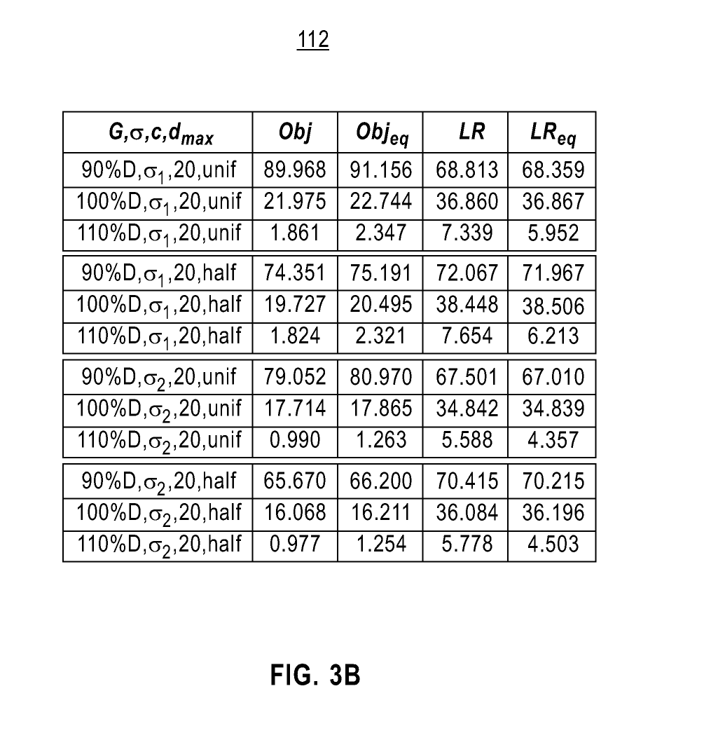

Example numerical experiments were performed for a variety of parameter settings. Tables I and II of respective FIGS. 3A, 3B provide a representative sample of the various parameter combinations for (G, σ, c, dₘₐₓ) in the experiments. Symbol G represents the utility's generation capacity, which was varied from 90% D (or a 10% shortfall in generation), 100% D and 110% D (or a 10% surplus in generation). All end-users' demand reduction elasticity were sampled from the same distribution U[0, 1], and thus all end users statistically exhibit the same mean demand reduction behavior. The symbol σ₁ indicates that the volatilities σ have been generated from a unimodal distribution, while σ₂ indicates the use of a bi-modal distribution for σ. A spot market cost multiplier c of 20 was chosen, which seems to be fairly typical of peak load conditions, e.g., during summer months.

As an example, two cases for modeling dₘₐₓ are considered:

$$\begin{matrix}{d}_{ma {x}_{i}} = \frac{{μ}_{i}}{2} , i = 1 , … , K , ( “ half ” ) & ( 8 ) \\ {d}_{ma {x}_{i}} = U [ 0.1 , 0.6 ] {μ}_{i} , i = 1 , … , K ( “ unif ” ) & ( 9 )\end{matrix}$$

In practice, the above exemplary parameters will be obtained from the demand response functions. That is, parameter values of 0.1, 0.6 are not fixed, but rather vary according to a customer's demand response function.

In these examples, the variables half and unif are referenced in Tables I and II of FIGS. 3A, 3B to indicate whether the dₘₐₓ is generated by (8) or (9), respectively. In the following, σ₁ is used to indicate single modal σ₁, and σ₂ for bi-modal σ. FIG. 3A depicts a first table 110 listing example parameter combinations for (G, σ, c, dₘₐₓ) in implementing the model using a Linear Bounded Load Reduction Function ƒᵢ. Likewise, FIG. 3B depicts a second table 112 listing example parameter combinations for (G, σ, c, dₘₐₓ) in implementing the model using a Non-Linear Load Reduction Function ƒᵢ. In the tables 110, 112 depicted in respective FIG. 3A, 3B, the values show what the cost objective is and what the load reduction is under the optimal solution. For example, this illutrates what the optimization does (however, rebates generated are not shown), i.e. what is the benefit to the utility. For example, in the line 116 of TABLE I, FIG. 3A, given example defined parameter combinations for (G, σ, c, dₘₐₓ) the optimal Obj function value is computed as 48.9 with different rebate values as contrasted to the Obj_{eq} function value computed as 56.50 denoting the optimal value obtained for the equal-rebate plan. As clearly seen in TABLE I line 116, by discriminating, it is demonstrated how the utility's cost is lowered. A corresponding increase in load reduction is also demonstrated at line 116 for these same parameters (G, σ, c, dₘₐₓ) by the value of LR (78.84) (under a scheme using different customized rebate values) as compared to the reduced load value of LR_{EQ} (71.0) obtained for the equal-rebate plan. Tables I and II further indicate that, in all cases, using an incentive scheme to drive demand reduction is by itself very valuable in comparison to paying spot market prices to close any generation shortfalls (e.g., the G=90% D cases). In addition, the discriminatory rebate scheme is able to achieve about 15-20% more cost reduction under this shortfall condition. These results are under the assumption that all end-users are statistically similar. The benefits of discriminatory incentives are even more significant under conditions where there are statistically distinct classes of customers.

That is, Tables 110, 112 depicted in respective FIG. 3A, 3B show that a customized rebate plan performs better than the equal-rebate mechanism. A variable ObjImp provides the objective value improvement for optimal rebate plan as compared to the equal-rebate plan, i.e., ObjImp=Obj_{eq}−Obj. The percentage of improvement is calculated as

ObjImp %=(Obj_{eq}−Obj)/Obj_{eg}.

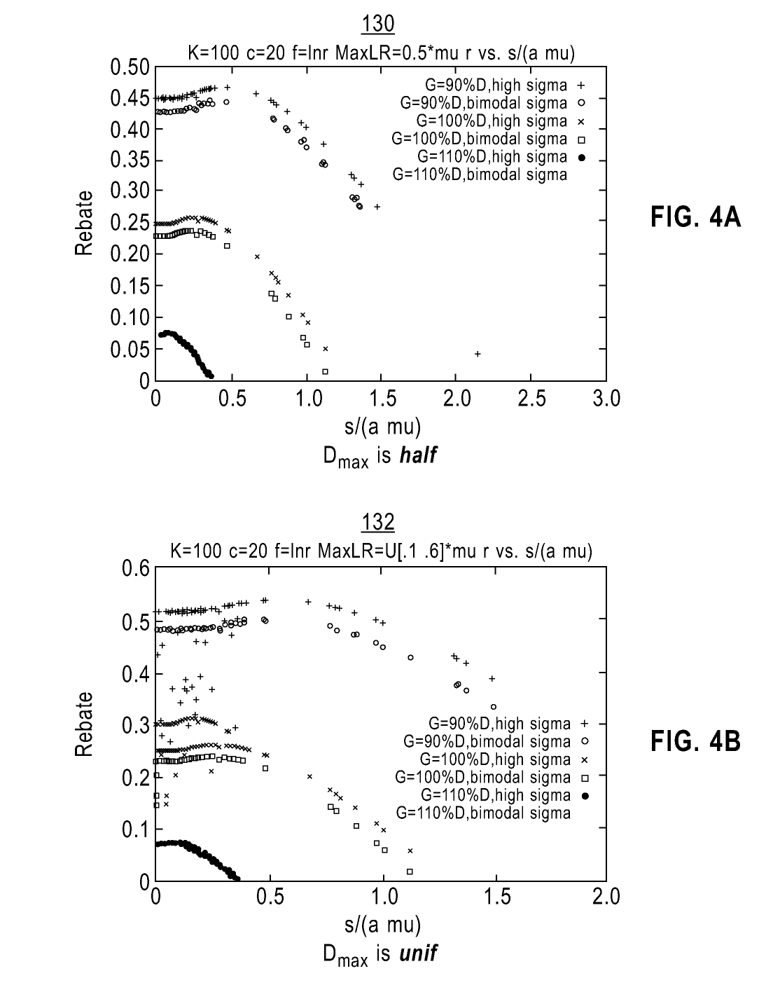

Numerical experiments were conducted for both cases of load reduction functions ƒ. FIG. 4A,B depict respective plots 130, 132 showing rebates

$$r vs . \frac{σ}{a μ}$$

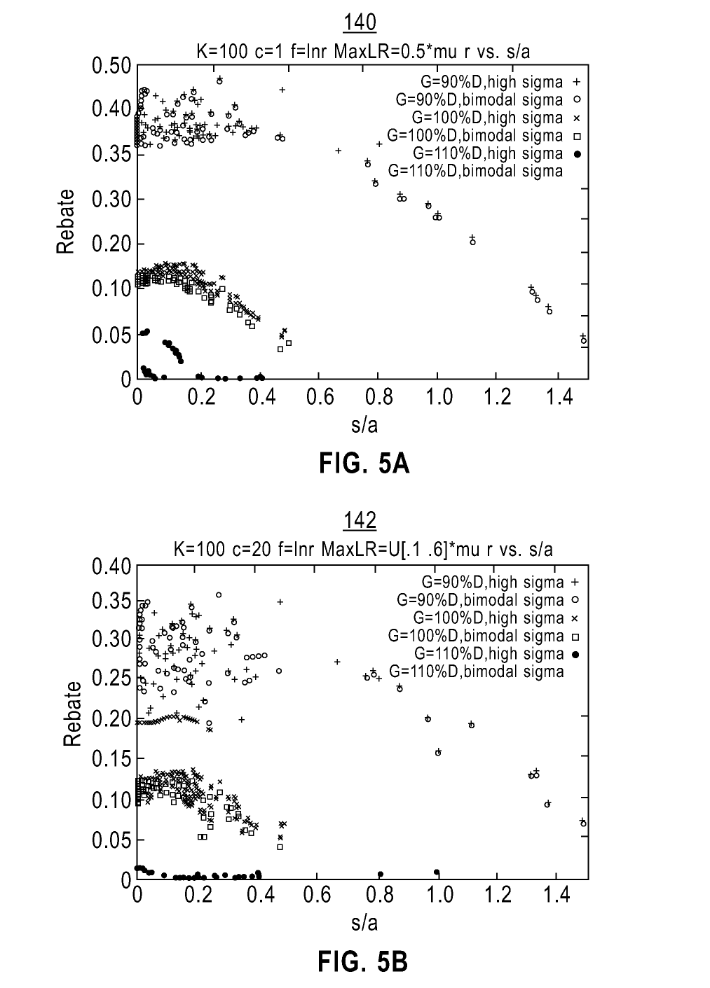

for linear ƒ such as set forth in equation (6) with K=100, c=1 for the example case where dₘₐₓ is half (FIG. 4A), and for the example case where dₘₐₓ is unif (FIG. 4B). FIG. 5A,B depict respective plots 140, 142 showing plots

$$r vs . \frac{σ}{a μ}$$

for nonlinear ƒ such as set forth in equation (7) with K=100, c=1 for the example case where dₘₐₓ is half (FIG. 5A) and for the example case where dₘₐₓ is unif (FIG. 5B). From FIGS. 4A,B and 5A,B, it is seen that when

$$\frac{σ}{a μ}$$

is large, r=0, and vice versa. Note that the quantity

$$\frac{σ}{μ}$$

is the (dimensionless) coefficient of variation of the end-user's demand. Thus, there exists a threshold for

$$\frac{σ}{a μ}$$

to “truncate” those end-users who exceed this threshold from being paid which is referred to herein as the

$$\frac{σ}{a μ}$$

—truncation policy. To calculate a good threshold value, there is considered some properties of the objective function:

Assumptions made include that if the load reduction function ƒ is concave, then the objective function

$$\frac{\partial Obj}{\partial {r}_{i}}$$

of equation (4) is convex. This follows from the fact that both forms for ƒ are concave, and the form of the objective function Obj and its derivative in equation (4). A threshold value result for

$$\frac{σ}{a μ}$$

such that rᵢ=0 is determined. In one embodiment rᵢ=0 iff

$$\frac{{σ}_{i}}{{a}_{i} {μ}_{i}} > c \sqrt{2 π} Φ ( β )$$

after the algorithm converges. That is, it the case that

$$\frac{{σ}_{i}}{{a}_{i} {μ}_{i}} > c \sqrt{2 π} Φ ( β )$$

is a sufficient condition for rᵢ to be 0. Thus, the value of

$$\frac{{σ}_{i}}{{a}_{i} {μ}_{i}} ,$$

i=1, . . . , K can be used to segment end-users, and pay no rebates to those whose

$$\frac{{σ}_{i}}{{a}_{i} {μ}_{i}}$$

value exceeds the threshold c\sqrt{2π}Φ(β). Thus the utility can exclude those end-users that are of no interest from the perspective of helping to reduce the load.

Consequently, a good “truncation” policy (approximation) is to segment the customers according to

$$\frac{{σ}_{i}}{{a}_{i} {μ}_{i}}$$

ratios wherein higher rebates are paid to customers with lower

$$\frac{{σ}_{i}}{{a}_{i} {μ}_{i}}$$

ratio, and vice versa, lower rebates are customers with higher

$$\frac{{σ}_{i}}{{a}_{i} {μ}_{i}}$$

ratio. Further, no rebates are paid to customers whose

$$\frac{{σ}_{i}}{{a}_{i} {μ}_{i}}$$

ratio exceeds a certain threshold.

Further, from Tables 110, 112 depicted in respective FIG. 3A, 3B, it is shown that load reduction for dₘₐₓ uniformly distributed between [0.10,0.6]μ is usually smaller than that when dₘₐₓ=0.5μ. The reason is that smaller dₘₐₓ is a tighter bound when dₘₐₓ is uniformly distributed than the fixed half-μ case, and thus the utility has a less total reduced load and a higher probability (Φ(β)) of buying from spot market.

Example numerical results such as provided herein show that gradient based Optimal-Rebate Plan (ORP) provides better performance compared to the Equal Rebate Plan (ERP) when the maximum amount of load reduction allowable dₘₐₓ is uniformly distributed rather than dₘₐₓ equaling half (e.g., 0.5) of the mean. This is because the uniform-dₘₐₓ case produces a more heterogenous user population, which in turn implies that the utility has a higher opportunity under the ORP which, in turn, implies that the utility has a higher chance to pay the spot-market penalty cost and is thus more receptive of the ORP. ORP performs better than ERP when there is a larger load shortage to cover. This is due to the fact that ORP can find and induce more total load reduction, resulting in smaller penalty costs. When the spot market price is more expensive, ORP again performs better than ERP. When the penalty cost is cheaper, the utility has a better choice to buy the load elsewhere rather than paying up till the maximum rebate level to obtain dₘₐₓ from each end-user. As previously noted, ORP provides even greater benefits over ERP when there are statistically distinct classes of customers, which often arise in practice.

The case of the linear load reduction function may have a larger improvement in total load reduced and total cost improvement than the case of the nonlinear function. This is because for the same amount of rebate, the linear case induces more load reduction than the nonlinear case. However, the two cases behave almost the same when the demand for load reduction is not significant. This is because the nonlinear load reduction is approximately equal to the linear one when the rebate amount is small.

Multiple Period Problem

The variables and parameters used by the multi-period formulation are essentially the same as those defined for the single-period formulation with an additional time (or period) index in the subscript, with other additions as described below. Recall that i=1, . . . , K indexes end-users and the new index t=1, . . . , T represents various time-periods.

T Time horizon, e.g., 24 (hours)

K Total number of end-users

Gₜ Total generation capacity at time t

d_{i,t} Demand level before rebate at time t if no load reduction occurs at times 1, . . . , t−1

d_{i,t}′ Actual demand level before rebate at time t with positive load reduction at time 1, . . . , t−1, where

$${d}_{i , t}^{′} = {d}_{i , t} + {\sum }_{j = 0}^{t - 1} δ {v}^{j} {f}_{i , t} ( {a}_{i , t - 1 - j} , {r}_{i , t - 1 - j} ) \qquad ( 10 )$$

wherein the demand reduction function ƒ_{i,t} is defined below.

δ,ν Factors that determine the amount of load that is shifted from one period to subsequent periods, with the factors satisfying the following stability condition:

$$\frac{δ}{1 - v} < 1$$

Total actual demand before rebate at time t, where

$${D}_{t} = {\sum }_{i = 1}^{K} {d}_{i , t}^{′} \qquad ( 11 )$$

[symbol] Forecast for d′i,t, the demand level before rebate;

d_{i,t}* is Demand level after rebate (assumed that d_{i,t}* are independent over i,t);

d_{i,t}^{ref} is Reference demand level below which load reduction by i qualifies for rebate at time t;

r_{i,t} Rebate per unit of demand reduction at time t;

σ_{i,t} End-user's “rebate elasticity”, or willingness to reduce load at time t;

f_{i,t} (a_{i,t}, r_{i,t}) Demand reduction function for the user with rebate elasticity a_{i,t} and rebate rate offered r_{i,t};

cₜ Spot market price at time t;

This formulation defines an additional set of variables d_{i,t}′ (i.e., actual demand level before rebate at time t) to capture the flexibility of end-users towards sustaining their demand reduction over time, and is used to model the shifting of load from one period to subsequent periods in an effort towards responding positively to the utility's rebate signals. The objective of the multi-period formulations is to minimize

$$E \{ \frac{1}{T} [ {\sum }_{t = 1}^{T} {\sum }_{i = 1}^{K} {{r}_{i , t} ( {d}_{i , t}^{ref} - {d}_{i , t}^{*} )}^{+} + {\sum }_{t = 1}^{T} {{c}_{t} [ {D}_{t} - {G}_{t} - {\sum }_{i = 1}^{K} ( {d}_{i , t}^{′} - {d}_{i , t}^{*} ) ]}^{+} ] \} , \qquad ( 12 )$$

subject to

d_{i,t}*=d_{i,t}′−ƒ_{i,t}(a_{i,t},r_{i,t}), i=1, . . . , K, t=1, . . . , T. (13)

The first term of the objective function represented in equation (12) represents the total rebate amount that the utility pays to all the customers during the period of time [0,T] for the amount of load reduced from the reference levels. Note that the utility accounts for a customer shifting load to available rebates in previous periods by setting the reference level appropriately, so that the rebate pricing is a reasonable indication of whether the load reduction by an end-user during peak hours is valuable. The second part of (12) is the utility's total cost in the spot market when there is still a shortage of load after rebates are offered.

In one embodiment, the OBJ denotes the objective function such as in equation (12). Assuming {d_{i,t}} follows a normal distribution N(μ_{i,t}, σ_{i,t}), where μ_{i,t} and σ_{i,t} are inferred by the utility from historical data, then similar to the reduction of the single period problem, with this assumption OBJ is further reduced to:

$$\begin{matrix}OBJ = \frac{1}{T} \{ \begin{matrix}\begin{matrix}\begin{matrix}{\sum }_{t = 1}^{T} {\sum }_{i = 1}^{K} {r}_{i , t} [ \begin{matrix}{d}_{i , t}^{ref} - {μ}_{i , t} - {\sum }_{j = 0}^{t - 2} δ {v}^{j} {f}_{i , t} ( {a}_{i , t - 1 - j} , {r}_{i , t - 1 - j} ) + \\ {f}_{i , t} ( {a}_{i , t} , {r}_{i , t} )\end{matrix} ] \\ Φ ( {α}_{i , t} ) + {\sum }_{t = 1}^{T} {\sum }_{i = 1}^{K} {r}_{i , t} {σ}_{i , t} φ ( {α}_{i , t} ) +\end{matrix} \\ {\sum }_{t = 1}^{T} {c}_{t} [ {\sum }_{i = 1}^{K} ( \begin{matrix}{μ}_{i , t} + {\sum }_{j = 0}^{t - 2} δ {v}^{j} {f}_{i , t} ( {a}_{i , t - 1 - j} , {r}_{i , t - 1 - j} ) - \\ {f}_{i , t} ( {a}_{i , t} , {r}_{i , t} )\end{matrix} ) - {G}_{t} ] Φ\end{matrix} \\ ( {β}_{t} ) + {\sum }_{t = 1}^{T} {c}_{t} \sqrt{{\sum }_{i = 1}^{K} {σ}_{i , t}^{2}} φ ( {β}_{t} )\end{matrix} \} & ( 14 ) \\ where & \\ {α}_{i , t} = {σ}_{i , t}^{- 1} ( {d}_{i , t}^{ref} - {μ}_{i , t} - {\sum }_{j = 0}^{t - 2} δ {v}^{j} {f}_{i , t} ( {a}_{i , t - 1 - j} , {r}_{i , t - 1 - j} ) + {f}_{i , t} ( {a}_{i , t} , {r}_{i , t} ) ) , & ( 15 ) \\ {β}_{t} = {( {\sum }_{i = 1}^{K} {σ}_{i , t}^{2} )}^{- \frac{1}{2}} ( {\sum }_{i = 1}^{K} ( \begin{matrix}{μ}_{i , t} + {\sum }_{j = 0}^{t - 2} δ {v}^{j} {f}_{i , t} ( {a}_{i , t - 1 - j} , {r}_{i , t - 1 - j} ) - \\ {f}_{i , t} ( {a}_{i , t} , {r}_{i , t} )\end{matrix} ) - {G}_{t} ) , & ( 16 )\end{matrix}$$

Letting OBJₛ be the objective value from period s with

$$OBJ = \frac{1}{T} {\sum }_{s = 1}^{T} {OBJ}_{s} ,$$

then if a choice is made that d_{i,t}^{ref}=\tilde{d}_{i,t}, this results in:

$$\frac{\partial OBJ}{\partial {r}_{i , t}} = \frac{1}{T} \{ \begin{matrix}[ {α}_{i , t} {σ}_{i , t} + {r}_{i , t} \frac{\partial {f}_{i , t} ( {a}_{i , t} , {r}_{i , t} )}{\partial {r}_{i , t}} ] Φ ( {α}_{i , t} ) + \\ {σ}_{i , t} φ ( {α}_{i , t} ) - {c}_{t} \frac{\partial {f}_{i , t} ( {a}_{i , r} , {r}_{i , t} )}{\partial {r}_{i , t}} {Φ}_{{β}_{t}}\end{matrix} \} + \frac{1}{T} {\sum }_{s = t + 1}^{T} \{ \begin{matrix}- {r}_{i , s} δ {v}^{s - t - 1} \frac{\partial {f}_{i , t} ( {a}_{i , t} , {r}_{i , t} )}{\partial {r}_{i , t}} Φ ( {α}_{i , s} ) + \\ {c}_{s} δ {v}^{s - t - 1} \frac{\partial {f}_{i , t} ( {a}_{i , r} , {r}_{i , t} )}{\partial {r}_{i , t}} Φ ( {β}_{s} )\end{matrix} \} . \qquad ( 17 )$$

With a choice of d_{i,t}^{ref}=d_{i,t}′, this results in:

$$\frac{\partial OBJ}{\partial {r}_{i , t}} = \frac{1}{T} \{ \begin{matrix}[ {α}_{i , t} {σ}_{i , t} + {r}_{i , t} \frac{\partial {f}_{i , t} ( {a}_{i , t} , {r}_{i , t} )}{\partial {r}_{i , t}} ] Φ ( {α}_{i , t} ) + \\ {σ}_{i , t} φ ( {α}_{i , t} ) - {c}_{t} \frac{\partial {f}_{i , t} ( {a}_{i , r} , {r}_{i , t} )}{\partial {r}_{i , t}} {Φ}_{{β}_{t}}\end{matrix} \} + \frac{1}{T} {\sum }_{s = t + 1}^{T} {c}_{s} δ {v}^{s - t - 1} \frac{\partial {f}_{i , t} ( {a}_{i , t} , {r}_{i , t} )}{\partial {r}_{i , t}} Φ ( {β}_{s} ) . \qquad ( 18 )$$

The same assumptions are made for the functional form of the load reduction function ƒ_{i,t} (a_{i,t}, r_{i,t}) as in the single-period formulation, which again yields a convex optimization problem in (12). In one embodiment, a steepest descent method is then employed with the gradient update obtained from the appropriate form of (18) or (17).

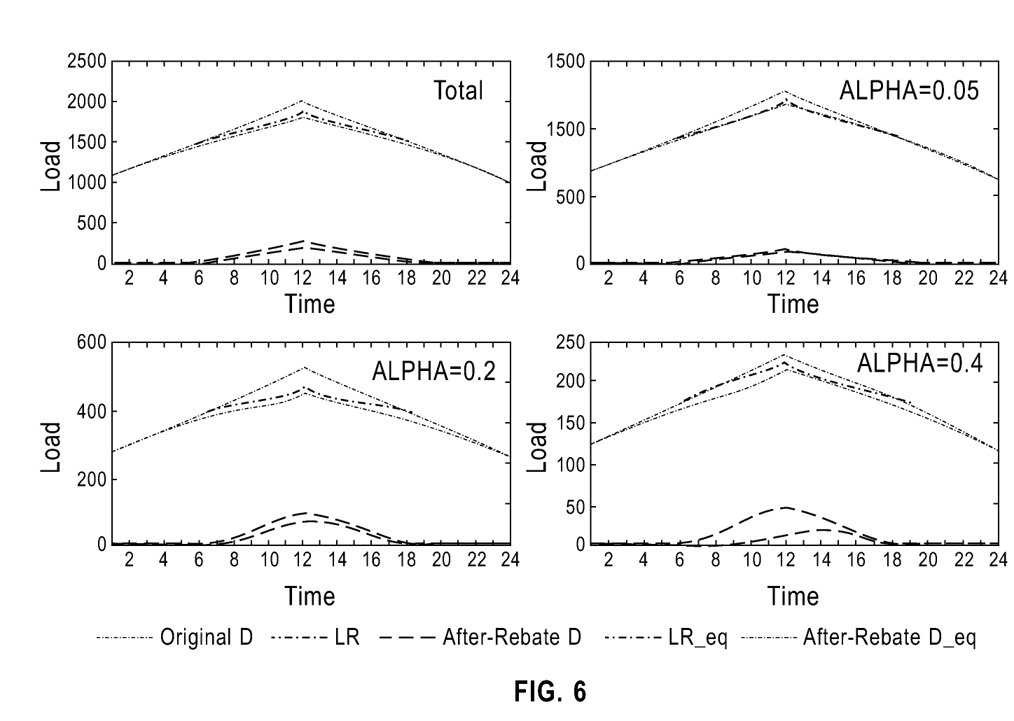

FIG. 6 depicts a plot of the original demand versus after-rebate demand level as well as the load reduction amount under both the optimal rebate plan (ORP) and equal-rebate plan (ERP). From the results, it is seen that customers with smaller load shifting factors (δ and ν) receive higher rebates, and vice versa. In addition, for the same supply shortfall, rebates after peak periods are higher than those before peak periods, in order to reduce load shifting into peak periods. More particularly, FIG. 6 depicts an original demand, after-rebate demand and load reduction as functions of time for T=24 hours, K=200, c=1. The multi-period model also accounts for the customer flexibility in reducing overall demand as exhibited by greater differences between ORP and ERP for customers with greater propensity to shift demand rather than reduce demand.

Thus, the numerical experiments show that for each single period, customers with higher rebate-demand elasticity and lower variance should be provided with higher incentive rates; and along multiple periods, customers with smaller likelihood of shifting their load and greater inclination to consume less over the entire horizon should be given higher rebates.

Referring back to FIG. 1, in one aspect, the SmartGrid may integrate smart devices that are part of managing an energy system including smart devices in homes, at the retail locations, offices, and so forth. These smart devices can be set up by a user to manage their unit however they like. For example, a homeowner may be willing to operate their air conditioning at 1-2 degrees higher provided that a rebate of at least a certain amount is provided.

Thus, a utility 20 can take advantage of this by exploiting the method and system of the invention to determine the optimal rebates for the different customers to minimize the various costs incurred by the utility (i.e., optimize the tradeoff between the costs of satisfying demand with existing energy generation and the costs of additional energy through the spot market). Once the utility has determined these rebates, then these rebates are communicated as incentive signals (price options) 23 to the customers to lower their energy demand/usage as a function of these rebates. This can be done at a very coarse level, or it can be done at much finer time scales where these “incentive signals” (rebates available upon lowering energy demand/usage) are sent to and responded to by the smart devices explained above. That is, rebates offered may account for certain user demand reduction devices, e.g., customers that use Smart Appliances, Programmable Thermostats, Energy Management Systems, etc. As an illustrative example, a utility may operate at a time scale of minutes while the ISO operates at a time scale of hours, although the present invention is not limited to such specific time scales.

The methodology described herein accounts for temporal aspects of demand shift in response for rebates wherein the costs can be financial, social, or their combinations, etc. As one example of a social cost, there is a social cost that could be related to reducing energy costs in general, given current global warming concerns, rather than demand shifts in response to rebates in order to reduce utility financial costs. The solution, then might not be the best financial solution for the entity, but rather one that minimizes a combination of financial and social costs. Note that the same formulation and optimization is used, but some of the details (e.g., what the function represents, how it is obtained, etc.) may be different.

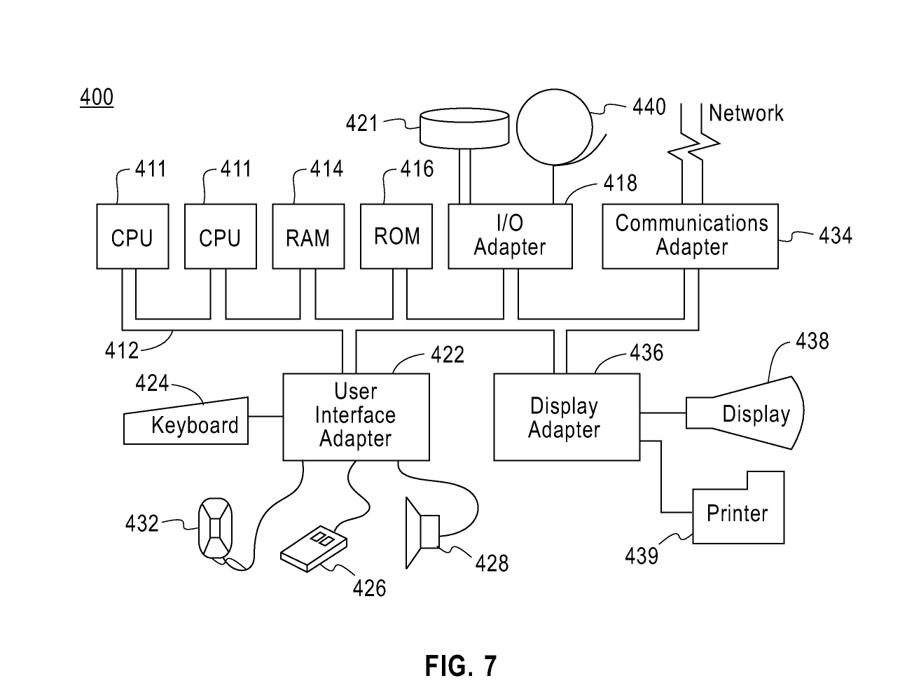

FIG. 7 illustrates an exemplary hardware configuration of a computing system 400 running and/or implementing the method steps described herein. The hardware configuration preferably has at least one processor or central processing unit (CPU) 411. The CPUs 411 are interconnected via a system bus 412 to a random access memory (RAM) 414, read-only memory (ROM) 416, input/output (I/O) adapter 418 (for connecting peripheral devices such as disk units 421 and tape drives 440 to the bus 412), user interface adapter 422 (for connecting a keyboard 424, mouse 426, speaker 428, microphone 432, and/or other user interface device to the bus 412), a communication adapter 434 for connecting the system 400 to a data processing network, the Internet, an Intranet, a local area network (LAN), etc., and a display adapter 436 for connecting the bus 412 to a display device 438 and/or printer 439 (e.g., a digital printer of the like).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with a system, apparatus, or device running an instruction.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with a system, apparatus, or device running an instruction. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may run entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations (e.g., FIG. 1) and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which run via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which run on the computer or other programmable apparatus provide processes for implementing the functions/acts specified in the flowchart and/or block diagram block or blocks.

The block diagrams in the Figures illustrate the architecture, functionality, and operation of possible implementations of systems, methods and computer program products according to various embodiments of the present invention. In this regard, each block in the flowchart or block diagrams may represent a module, segment, of portion of code, which comprises one or more operable instructions for implementing the specified logical function(s). It should also be noted that, in some alternative implementations, the functions noted in the block may occur out of the order noted in the figures. For example, two blocks shown in succession may, in fact, be run substantially concurrently, or the blocks may sometimes be run in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While there has been shown and described what is considered to be preferred embodiments of the invention, it will, of course, be understood that various modifications and changes in form or detail could readily be made without departing from the spirit of the invention. It is therefore intended that the scope of the invention not be limited to the exact forms described and illustrated, but should be construed to cover all modifications that may fall within the scope of the appended claims.

Having thus described our invention, what we claim as new, and desire to secure by Letters Patent is:

1. A computer-implemented method to estimate a price for determining an aggregate energy demand reduction for plurality of end-users of an entity supplying power to said end-users, said method comprising:
a) receiving, at a processor device, data including a plurality of energy users i including, for each energy user, their demand level for energy usage and an incentive rebate cost per unit of demand reduction;
b) generating a customized time-varying incentive plan for each individual user i, in a defined time period, by minimizing the total incentive rebate amounts that said entity pays to each end-user i for load reduction, and a total purchasing cost in case of a load shortage;
c) communicating signals from said entity to each respective user i, said signals carrying data representing an incentive plan calculated to reduce the user i's energy demand for said time period,
wherein a cost expenditure of said entity is minimized.

2. The computer-implemented method as claimed in claim 1, wherein said generating comprises: formulating, at said processor device, an objective function to be minimized, said objective function representing a total cost for demand reduction and a total cost of purchasing energy via a market.

3. The computer-implemented method as claimed in claim 2, wherein said objective function OBJ is formulated as:
$$E \{ {\sum }_{i = 1}^{K} {{r}_{i} ( {\tilde{d}}_{i} - {d}_{i}^{*} )}^{+} + {c [ D - G - {\sum }_{i = 1}^{K} ( {d}_{i} - {d}_{i}^{*} ) ]}^{+} \}$$
subject to a constraint that
dᵢ*=dᵢ−ƒᵢ(aᵢ,rᵢ)
where i is i=1, . . . , K, K is total number of end-users; G is total generation capacity; dᵢ is demand level for user i before rebate; D is total demand before rebate, where
$$D = {\sum }_{i = 1}^{k} {d}_{i}$$
where [symbol] is forecast demand level before rebate; dᵢ* is demand level after rebate; ƒᵢ (aᵢ, rᵢ) is a demand reduction function characterizing how user i responds to a given rebate value, where aᵢ is an user's rebate-demand elasticity; and rᵢ is a rebate per unit of demand reduction; and, c is a current marginal market price for purchasing energy for excess load after incentives are offered, and ( [symbol] −dᵢ*) is the Load Reduction.

4. The computer-implemented method as claimed in claim 3, further comprising:
constructing, for each respective customer i, said load reduction function ƒᵢ (aᵢ, rᵢ) based on historical demand response data for said respective user i each said load reduction function ƒᵢ satisfying a condition
$$\frac{\partial {f}_{i} ( {a}_{i} , {r}_{i} )}{\partial {r}_{i}} {l}_{{r}_{i} = 0} = {a}_{i} , i = 1 , … , K .$$

5. The computer-implemented method as claimed in claim 2, wherein said cost being minimized is a financial cost, a social cost, or a combination thereof.

6. The computer-implemented method as claimed in claim 4, wherein ƒᵢ (aᵢ, rᵢ) is a Linear Bounded Load Reduction function ƒᵢ(aᵢ, rᵢ)=min {aᵢrᵢ, dₘₐₓ}, i=1, . . . , K that reduces the load linearly as the rebate rate rᵢ increases until an upper bound for demand, dₘₐₓ, is reached.

7. The computer-implemented method as claimed in claim 4, wherein ƒᵢ (aᵢ, rᵢ) is a Non-linear Bounded Load Reduction function and converges to an upper bound for demand, dₘₐₓ, according to:
$${f}_{i} ( {a}_{i} , {r}_{i} ) = {d}_{{max}_{i}} - \frac{1}{{a}_{i} {r}_{i} + \frac{1}{{d}_{{max}_{i}}}} , i = 1 , … , K .$$

8. The computer-implemented method as claimed in claim 3, wherein said generating a customized time-varying incentive plan for each user i comprises solving said objective function OBJ using a gradient descent technique.

9. The computer-implemented method as claimed in claim 3, wherein an incentive plan includes a price rebate for a requested demand reduction, said method further comprising:
determining a segmentation threshold for computing user incentive levels; and,
computing and communicating an incentive plan for users characterized as having a
$$\frac{{σ}_{i}}{{a}_{i}}$$
ratio that is below said segmentation threshold and avoiding computing an incentive plan for users characterized as having a
$$\frac{{σ}_{i}}{{a}_{i}}$$
ratio that exceeds said segmentation threshold,
wherein dᵢ is characterized as a probability having a normal distribution N(μᵢ, σᵢ) having a mean distribution value μᵢ and a standard deviation value σᵢ are known to the entity from said historical data.

10. The computer-implemented method as claimed in claim 2, wherein said generating a customized time-varying incentive plan for each user i is calculated for multiple time periods, wherein said objective function OBJ is formulated as:
$$E \{ \frac{1}{T} [ {\sum }_{t = 1}^{T} {\sum }_{i = 1}^{K} {{r}_{i , t} ( {d}_{i , t}^{ref} - {d}_{i , t}^{*} )}^{+} + {\sum }_{t = 1}^{T} {{c}_{t} [ {D}_{t} - {G}_{t} - {\sum }_{i = 1}^{K} ( {d}_{i , t}^{′} - {d}_{i , t}^{*} ) ]}^{+} ] \} ,$$
subject to a constraint that
d_{i,t}*=d_{i,t}′−ƒ_{i,t}(a_{i,t},r_{i,t}), i=1, . . . , K, t=1, . . . , T
and subject to a further constraint that
$${d}_{i , t}^{′} = {d}_{i , t} + {\sum }_{j = 0}^{t - 1} δ {v}^{j} {f}_{i , t} ( {a}_{i , t - 1 - j} , {r}_{i , t - 1 - j} ) ,$$
where i is i=1, . . . , K, t=1, . . . , T represents said multiple time-periods and T represents a time horizon, G, represents a total generation capacity at time t; d_{i,t} is a demand level before rebate at time t if no load reduction occurs at times 1, . . . , t−1; d_{i,t}* is a demand level after rebate; d_{i,t}′ is an actual demand level before rebate at time t with positive load reduction at time 1, . . . , t−1, and models, for a user i, a shifting of load from one period to subsequent periods when responding to an entity's communicated incentive signals, wherein δ, ν are factors that determine an amount of load that is shifted from one time period to subsequent time periods; Dₜ is a total actual demand before incentive at time t, where
$${D}_{t} = {\sum }_{i = 1}^{K} {d}_{i , t}^{′} ;$$ [symbol]
is a forecast for d′i,t, the demand level before incentive; d_{i,t}^{ref} is a reference demand level below which load reduction by i qualifies for incentive at time t; r_{i,t} is a rebate per unit of demand reduction at time t; α_{i,t} is a user's willingness to reduce load at time t; ƒ_{i,t} (a_{i,t}, r_{i,t}) is a demand reduction function for user i with rebate elasticity a_{i,t} and rebate rate offered r_{i,t} and, cₜ a marginal market price at time t to be purchased in event of load shortage; and (d_{i,t}′−d_{i,t}*) is the Load Reduction for user i at time t,
said method computing for each user i, a value of reducing load for a peak period at an expense of shifting load to a later time period.

11. A system for estimating a price for determining an aggregate energy demand reduction for plurality of end-users of an entity supplying power to said end-users, said system comprising:
a memory storage device; and
a processor storage device connected to the memory storage device,
wherein the processor performs:
a) receiving, at a processor device, data including a plurality of energy users i including, for each energy user, their demand level for energy usage, and an incentive rebate cost per unit of demand reduction;
b) generating a customized time-varying incentive plan for each individual user i, in a defined time period, by minimizing the total incentive rebate amount that said entity pays to each end-user i for load reduction, and a total purchasing cost in case of a load shortage;
c) communicating signals from said entity to each respective user i, said signals carrying data representing an incentive plan calculated to reduce the user i's energy demand for said time period,
wherein a cost expenditure of said entity is minimized.

12. The system as claimed in claim 11, wherein said generating comprises: formulating, at said processor device, an objective function to be minimized, said objective function representing a total cost for demand reduction and a total cost of purchasing energy via a market.

13. The system as claimed in claim 12, objective function OBJ is formulated as:
$$E \{ {\sum }_{i = 1}^{K} {{r}_{i} ( {\tilde{d}}_{i} - {d}_{i}^{*} )}^{+} + {c [ D - G - {\sum }_{i = 1}^{K} ( {d}_{i} - {d}_{i}^{*} ) ]}^{+} \}$$
subject to a constraint that
dᵢ*=dᵢ−ƒᵢ(aᵢ,rᵢ)
where i is i=1, . . . , K, K is total number of end-users; G is total generation capacity; dᵢ is demand level for user i before rebate; D is total demand before rebate, where
$$D = {\sum }_{i = 1}^{k} {d}_{i}$$
where [symbol] is forecast demand level before rebate; dᵢ* is demand level after rebate; ƒᵢ (aᵢ, rᵢ) is a demand reduction function characterizing how user i responds to a given rebate value, where aᵢ is an user's rebate-demand elasticity; and rᵢ is a rebate per unit of demand reduction; and, c is a current marginal market price for purchasing energy for excess load after incentives are offered, and [symbol] −dᵢ*) is the Load Reduction.

14. The system as claimed in claim 13, further comprising:
constructing, for each respective customer i, said load reduction function ƒᵢ (aᵢ, rᵢ) based on historical demand response data for said respective user i, each said load reduction functions ƒᵢ satisfy a condition:
$$\frac{\partial {f}_{i} ( {a}_{i} , {r}_{i} )}{\partial {r}_{i}} {l}_{{r}_{i} = 0} = {a}_{i} , i = 1 , … , K .$$

15. The system as claimed in claim 14, wherein ƒᵢ(aᵢ, rᵢ) is a Linear Bounded Load Reduction function ƒᵢ(aᵢ, rᵢ)=min {aᵢrᵢ, dₘₐₓ}, i=1, . . . , K that reduces the load linearly as the rebate rate rᵢ increases until an upper bound for demand, dₘₐₓ, is reached.

16. The system as claimed in claim 14, wherein ƒᵢ(aᵢ, rᵢ) is a Non-linear Bounded Load Reduction function and converges to an upper bound demand, dₘₐₓ, according to:
$${f}_{i} ( {a}_{i} , {r}_{i} ) = {d}_{{max}_{i}} - \frac{1}{{a}_{i} {r}_{i} + \frac{1}{{d}_{{max}_{i}}}} , i = 1 , … , K .$$

17. The system as claimed in claim 13, wherein said generating a customized time-varying incentive plan for each user i comprises solving said objective function OBJ using a gradient descent technique.

18. The system as claimed in claim 13, wherein an incentive plan includes a price rebate for a requested demand reduction, said method further comprising:
determining a segmentation threshold for computing user incentive levels; and, computing and communicating an incentive plan for users characterized as having a
$$\frac{{σ}_{i}}{{a}_{i}}$$
ratio that is below said segmentation threshold and avoiding computing an incentive plan for users characterized as having a
$$\frac{{σ}_{i}}{{a}_{i}}$$
ratio that exceeds said segmentation threshold,
wherein dᵢ is characterized as a probability having a normal distribution N(μᵢ, σᵢ) having a mean distribution value μᵢ and a standard deviation value σᵢ are known to the entity from said historical data.

19. The system as claimed in claim 12, wherein said generating a customized time-varying incentive plan for each user i is calculated for multiple time periods, wherein said objective function OBJ is formulated as:
$$E \{ \frac{1}{T} [ {\sum }_{t = 1}^{T} {\sum }_{i = 1}^{K} {{r}_{i , t} ( {d}_{i , t}^{ref} - {d}_{i , t}^{*} )}^{+} + {\sum }_{t = 1}^{T} {{c}_{t} [ {D}_{t} - {G}_{t} - {\sum }_{i = 1}^{K} ( {d}_{i , t}^{′} - {d}_{i , t}^{*} ) ]}^{+} ] \}$$
subject to a constraint that
d_{i,t}*=d_{i,t}′−ƒ_{i,t}(a_{i,t},r_{i,t}), i=1, . . . , K, t=1, . . . , T
and subject to a further constraint that
$${d}_{i , t}^{′} = {d}_{i , t} + {\sum }_{j = 0}^{t - 1} δ {v}^{j} {f}_{i , t} ( {a}_{i , t - 1 - j} , {r}_{i , t - 1 - j} ) ,$$
where i is i=1, . . . , K, t=1, . . . , T represents said multiple time-periods and T represents a time horizon, G, represents a total generation capacity at time t; d_{i,t} is a demand level before rebate at time t if no load reduction occurs at times 1, . . . , t−1; d_{i,t}* is a demand level after rebate; d_{i,t}′ is an actual demand level before rebate at time t with positive load reduction at time 1, . . . , t−1, and models, for a user i, a shifting of load from one period to subsequent periods when responding to an entity's communicated incentive signals, wherein δ, ν are factors that determine an amount of load that is shifted from one time period to subsequent time periods; Dₜ is a total actual demand before incentive at time t; where
$${D}_{t} = {\sum }_{i = 1}^{K} {d}_{i , t}^{′} ;$$ [symbol]
is a forecast for d′i,t, the demand level before incentive; d_{i,t}^{ref} is a reference demand level below which load reduction by i qualifies for incentive at time t; r_{i,t} is a rebate per unit of demand reduction at time t; a_{i,t} is a user's willingness to reduce load at time t; ƒ_{i,t}(a_{i,t}, r_{i,t}) is a demand reduction function for user i with rebate elasticity a_{i,t} and rebate rate offered r_{i,t} and, cₜ is a marginal market price at time t to be purchased in event of load shortage; and (d_{i,t}′−d_{i,t}*) is the Load Reduction for user i at time t,
said method computing for each user i, a value of reducing load for a peak period at an expense of shifting load to later time periods.

20. A computer program device for estimating a price for determining an aggregate energy demand reduction for plurality of end-users of an entity supplying power to said end-users, the computer program device comprising a storage medium readable by a processing circuit and storing instructions run by the processing circuit for performing a method, the method comprising:
a) receiving, at a processor device, data including a plurality of energy users i including, for each energy user, their demand level for energy usage, and an incentive rebate cost per unit of demand reduction;
b) generating a customized time-varying incentive plan for each individual user i, in a defined time period, by minimizing the total incentive rebate amounts that said entity pays to each end-user i for load reduction, and a total purchasing cost in case of a load shortage;
c) communicating signals from said entity to each respective user i, said signals carrying data representing an incentive plan calculated to reduce the user i's energy demand for said time period,
wherein a cost expenditure of said entity is minimized.

21. The computer program device as claimed in claim 20, wherein said generating comprises: formulating, at said processor device, an objective function to be minimized, said objective function representing a total cost for demand reduction and a total cost of purchasing energy via a market

22. The computer program device as claimed in claim 21, wherein said objective function OBJ is formulated as:
$$E \{ {\sum }_{i = 1}^{K} {{r}_{i} ( {\tilde{d}}_{i} - {d}_{i}^{*} )}^{+} + {c [ D - G - {\sum }_{i = 1}^{K} ( {d}_{i} - {d}_{i}^{*} ) ]}^{+} \}$$
subject to a constraint that
dᵢ*=dᵢ−ƒᵢ(aᵢ,rᵢ)
where i is i=1, . . . , K, K is total number of end-users; G is total generation capacity; dᵢ
is demand level for user i before rebate; D is total demand before rebate, where
$$D = {\sum }_{i = 1}^{k} {d}_{i}$$
where [symbol]
is forecast demand level before rebate; dᵢ* is demand level after rebate; ƒᵢ(aᵢ, rᵢ) is a demand reduction function characterizing how user i responds to a given rebate value, where aₜ is an user's rebate-demand elasticity; and rᵢ is a rebate per unit of demand reduction; and, c is a current market price for purchasing energy for excess load after incentives are offered, and ( [symbol] −dᵢ*) is the Load Reduction.

23. The computer program device as claimed in claim 22, further comprising:
constructing, for each respective customer i, said load reduction function ƒᵢ(aᵢ, rᵢ) based on historical demand response data for said respective user i.

24. The computer program device as claimed in claim 21, wherein said generating a customized time-varying incentive plan for each user i is calculated for multiple time periods, wherein said objective function OBJ is formulated as:
$$E \{ \frac{1}{T} [ {\sum }_{t = 1}^{T} {\sum }_{i = 1}^{K} {{r}_{i , t} ( {d}_{i , t}^{ref} - {d}_{i , t}^{*} )}^{+} + {\sum }_{t = 1}^{T} {{c}_{t} [ {D}_{t} - {G}_{t} - {\sum }_{i = 1}^{K} ( {d}_{i , t}^{′} - {d}_{i , t}^{*} ) ]}^{+} ] \}$$
subject to a constraint that
d_{i,t}*=d_{i,t}′−ƒ_{i,t}(ai,t,r_{i,t}), i=1, . . . , K, t=1, . . . , T
and subject to a further constraint that
$${d}_{i , t}^{′} = {d}_{i , t} + {\sum }_{j = 0}^{t - 1} δ {v}^{j} {f}_{i , t} ( {a}_{i , t - 1 - j} , {r}_{i , t - 1 - j} ) ,$$
where i is i=1, . . . , K, t=1, . . . , T represents said multiple time-periods and T represents a time horizon, Gₜ represents a total generation capacity at time t; d_{i,t}* is a demand level before rebate at time t if no load reduction occurs at times 1, . . . , t−1; d_{i,t}* is a demand level after rebate; d_{i,t}′ is an actual demand-level before rebate at time t with positive load reduction at time 1, . . . , t−1, and models, for a user i, a shifting of load from one period to subsequent periods when responding to an entity's communicated incentive signals, wherein δ, ν are factors that determine an amount of load that is shifted from one time period to subsequent time periods; D, is a total actual demand before incentive at time t, where
$${D}_{t} = {\sum }_{i = 1}^{K} {d}_{i , t}^{′} ;$$ [symbol]
is a forecast for d′i,t, the demand level before incentive; d_{i,t}^{ref} is a reference demand level below which load reduction by i qualifies for incentive at time t; r_{i,t} is a rebate per unit of demand reduction at time t; a_{i,t} is a user's willingness to reduce load at time t; ƒ_{i,t}(a_{i,t}, r_{i,t}) is a demand reduction function for user i with rebate elasticity a_{i,t} and rebate rate offered r_{i,t} and, cₜ market price at time t to be purchased in event of load shortage; and (d′_{i,t}−d_{i,t}*) is the Load Reduction for user i at time t,
said method computing for each user i, a value of reducing load for a peak period at an expense of shifting load to later time periods.

25. The computer program device as claimed in claim 21, wherein an incentive plan includes a price rebate for a requested demand reduction, said method further comprising:
determining a segmentation threshold for computing user incentive levels; and,
computing and communicating an incentive plan for users characterized as having a
$$\frac{{σ}_{i}}{{a}_{i}}$$
ratio that is below said segmentation threshold and avoiding computing an incentive plan for users characterized as having a
$$\frac{{σ}_{i}}{{a}_{i}}$$
ratio that exceeds said segmentation threshold,
wherein dᵢ is characterized as a probability having a normal distribution N(μᵢ, σᵢ) having a mean distribution value μᵢ and a standard deviation value σᵢ are known to the entity from said historical data.
